(19) United States
(12) Patent Application Publication
(10) Pub. No.: US 2025/0123974 A1
(43) Pub. Date: Apr. 17, 2025

(54) DETERMINATION OF ACTIVE AND STANDBY SMART NICS THROUGH DATAPATH

(71) Applicant: VMware LLC, Palo Alto, CA (US)

(72) Inventors: Ankur Kumar Sharma, Mountain View, CA (US); Wenyi Jiang, Fremont, CA (US)

(21) Appl. No.: 18/380,859

(22) Filed: Oct. 17, 2023

(51) Int. Cl. G06F 13/12

(52) U.S. Cl. CPC G06F 13/128

(57) ABSTRACT

Some embodiments provide a method for a first smart NIC of multiple smart NICs of a host computer. Each of the smart NICs executes a smart NIC operating system that performs networking operations for a set of data compute machines executing on the host computer. When the first smart NIC identifies itself as an active smart NIC for the host computer, the first smart NIC sends a first message through a datapath to a second smart NIC to verify whether the second smart NIC identifies as an active smart NIC or a standby smart NIC. If the second smart NIC sends a reply second message to the first smart NIC through the datapath, the first smart NIC (i) determines that the second smart NIC identifies as a standby smart NIC and (ii) operates to process data traffic sent to and from the host computer as the active smart NIC.

### BACKGROUND

More operations normally associated with a host computer are being pushed to programmable smart network interface controllers (NICs). Some of the operations pushed to these smart NICs include network processing of data messages that would previously be handled in the hypervisor. In some cases, a host computer will have multiple such smart NICs performing network processing or other operations. It is important in many situations that the physical network only identifies one of these smart NICs as the active smart NIC for a host computer (or for a specific data compute node on the host computer), so methods of ensuring that only one smart NIC is active at a given time are important.

### BRIEF SUMMARY

Some embodiments provide a datapath-based method for a first smart network interface controller (NIC) of a host computer to determine whether itself or a second smart NIC of the host computer should operate as the active smart NIC in an active-standby pair. This process may be performed by one or both of the smart NICs in the pair in some embodiments, depending on the status of those smart NICs. In some embodiments, the smart NICs each execute a smart NIC operating system that performs networking operations (e.g., virtual networking operations) for the host computer (e.g., for a set of data compute nodes such as virtual machines, containers, etc. that execute on the host computer. While a local controller executing on the host computer (e.g., within virtualization software of the host computer) can assign active and standby status to the smart NICs during typical operation, some embodiments require a method that is robust to situations in which the virtualization software is not available (e.g., because the host computer has rebooted).

Specifically, when the first smart NIC believes that it should be the active smart NIC, that first smart NIC sends a first message through the datapath to the second smart NIC (e.g., via a direct communication channel or via the physical datacenter network that connects the two smart NICs). If the second smart NIC is operating as the standby smart NIC, then the second smart NIC sends a reply second message that indicates that (i) it is the standby smart NIC and (ii) the first smart NIC should operate as the active smart NIC. However, if the second smart NIC also believes that it should be the active smart NIC, the second smart NIC will send its own first message (i.e., a message that matches the first message from the first smart NIC except that the direction of the message is reversed). In the latter case, when both smart NICs believe themselves to be the active smart NIC, both of the smart NICs use a deterministic process to identify which should operate as the active and which should operate as the standby (ensuring that they reach the same conclusion). Whichever smart NIC identifies itself as the one to operate as the standby sends a reply second message to the other, ensuring that the other will operate as the active smart NIC for the host computer.

In some embodiments, the first message is a polling sequence initiation message (e.g., a bidirectional forwarding detection (BFD) poll sequence poll (P) message) and the reply second message is a polling sequence termination message (e.g., a BFD poll sequence final (F) message). Thus, if both smart NICs believe themselves to be active, then both initiate poll sequences with the other and, depending on the result of the deterministic process, only one of the smart NICs completes the poll sequence by sending a termination message.

As noted above, if both smart NICs believe themselves to be the active smart NIC, then both perform the same deterministic process to determine which should be active. In some embodiments, this process is a comparison of hardware identifiers of the two smart NICs to which both of the smart NIC have access. For instance, in some embodiments, the smart NICs connect to the host computer via a peripheral component interconnect express (PCIe) bus and each smart NIC has its own PCIe identifier, so both smart NICs compare these identifiers and identify the smart NIC with the higher (or lower) value as the active smart NIC. The other smart NIC (identified as standby) thus sends the reply message.

Other embodiments compare the timestamps of the most recent configuration update for the two smart NICs. In this case, the first messages sent in each direction (e.g., the poll sequence initiation messages) include the timestamp of the most recent configuration for the sending smart NIC, thereby allowing the two smart NICs to make the same comparison. If both smart NICs were most recently updated at the same time, then the smart NICs compare the hardware identifiers as a tiebreaker in some embodiments. The smart NICs perform networking for the DCNs operating on the host computer, which may require regular configuration changes as the logical networks to which the DCNs belong are modified (e.g., as DCNs are added or removed from the virtual network, as new security policies are defined, etc.). As such, the configuration for the smart NICs will be updated relatively often in many cases.

As indicated previously, in typical operation (i.e., with the host computer and the smart NICs all operating normally) a controller agent operating in the virtualization software could specify to the smart NICs which one operates as active and which operates as standby. However, situations such as crashes or deliberate reboots of either the host computer or individual smart NICs can result in situations requiring solutions that do not involve the host computer software (thus the impetus for a datapath-based solution).

For instance, if the entire host computer crashes (or is deliberately restarted), the smart NICs will often be up and running prior to the virtualization software of the host computer (or the DCNs executing on the host computer). While there is no need to send traffic from the host computer at this point, it is possible that traffic could be sent to the host computer. Furthermore, in some embodiments, the smart NIC acts as a replication proxy within the datacenter for broadcast, multicast, and/or unknown destination (BUM) traffic, even if the host computer is not yet operating. In addition, if one of the smart NICs crashes (or is deliberately powered off), the optimal solution for determining which smart NIC is active when that smart NIC comes back up should not require intervention of the virtualization software.

When one of the smart NICs comes back up, that smart NIC is configured to automatically send out the first (e.g., poll sequence initiation) message upon booting up if it identifies itself as active. For the other smart NIC to be made aware and thus send its own first message (if identifying itself as active), in some embodiments the PCIe bus automatically sends a hardware event signal to the other smart NIC when the first smart NIC has restarted. In other embodiments, the smart NICs maintain a BFD (or other health monitoring protocol) session while both are running. Upon coming back up, the smart NIC that restarted will automatically re-initiate this session (or continue sending the BFD messages for the previous session), thereby indicating to the other smart NIC that it has restarted.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matters are not to be limited by the illustrative details in the Summary, Detailed Description, and the Drawings, but rather are to be defined by the appended claims, because the claimed subject matters can be embodied in other specific forms without departing from the spirit of the subject matters.

### BRIEF DESCRIPTION OF THE DRAWINGS

The novel features of the invention are set forth in the appended claims. However, for purpose of explanation, several embodiments of the invention are set forth in the following figures.

FIG. 1 conceptually illustrates a host computer with multiple physical smart NICs that perform network virtualization operations.

FIG. 2 conceptually illustrates a process of some embodiments performed by a smart NIC to determine whether that smart NIC is the active smart NIC for a host computer.

FIG. 3 conceptually illustrates a situation in which an entire host computer crashes (or is deliberately restarted) over five stages.

FIG. 4 conceptually illustrates a situation in which one of the smart NICs crashes (or is deliberately powered off), then comes back online over five stages.

FIG. 5 conceptually illustrates the two P messages sent by the smart NICs at the third stage of FIG. 4.

FIG. 6 conceptually illustrates an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide a datapath-based method for a first smart network interface controller (NIC) of a host computer to determine whether itself or a second smart NIC of the host computer should operate as the active smart NIC in an active-standby pair. This process may be performed by one or both of the smart NICs in the pair in some embodiments, depending on the status of those smart NICs. In some embodiments, the smart NICs each execute a smart NIC operating system that performs networking operations (e.g., virtual networking operations) for the host computer (e.g., for a set of data compute nodes such as virtual machines, containers, etc. that execute on the host computer. While a local controller executing on the host computer (e.g., within virtualization software of the host computer) can assign active and standby status to the smart NICs during typical operation, some embodiments require a method that is robust to situations in which the virtualization software is not available (e.g., because the host computer has rebooted).

Specifically, when the first smart NIC believes that it should be the active smart NIC, that first smart NIC sends a first message through the datapath to the second smart NIC (e.g., via a direct communication channel or via the physical datacenter network that connects the two smart NICs). If the second smart NIC is operating as the standby smart NIC, then the second smart NIC sends a reply second message that indicates that (i) it is the standby smart NIC and (ii) the first smart NIC should operate as the active smart NIC. However, if the second smart NIC also believes that it should be the active smart NIC, the second smart NIC will send its own first message (i.e., a message that matches the first message from the first smart NIC except that the direction of the message is reversed). In the latter case, when both smart NICs believe themselves to be the active smart NIC, both of the smart NICs use a deterministic process to identify which should operate as the active and which should operate as the standby (ensuring that they reach the same conclusion). Whichever smart NIC identifies itself as the one to operate as the standby sends a reply second message to the other, ensuring that the other will operate as the active smart NIC for the host computer.

Before describing this process in detail, the smart NICs of some embodiments will be described. The smart NICs, in some embodiments, include a general-purpose processor and memory and thus have the capability of performing more operations than a traditional NIC. In some embodiments, the smart NICs execute a smart NIC operating system, enabling the smart NIC to perform various tasks that would otherwise be performed by the host computer software (e.g., the hypervisor of the host computer). These tasks can include virtual network processing for data messages (i.e., performing virtual switching and/or routing, firewall operations, etc.), virtual storage operations, etc.

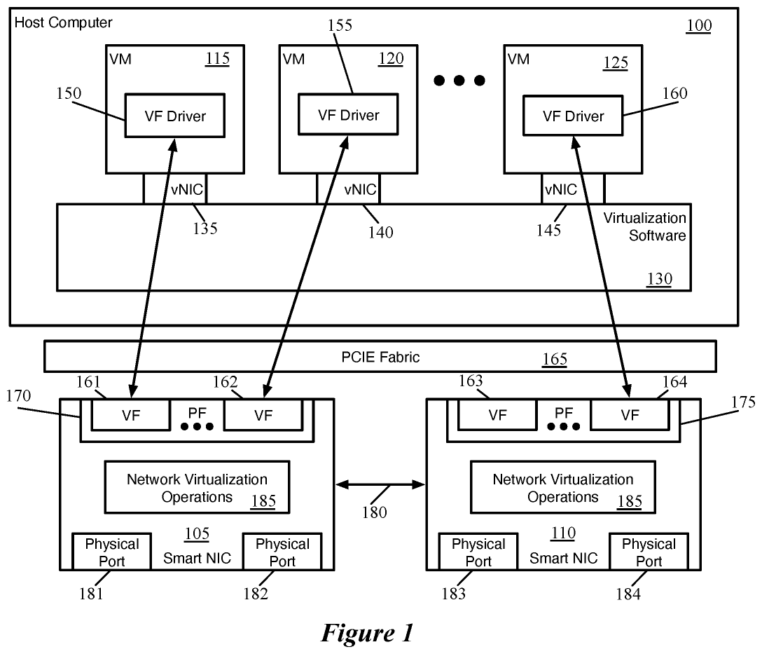

FIG. 1 conceptually illustrates a host computer 100 with multiple physical smart NICs 105 and 110 that perform network virtualization operations. As shown, the host computer 100 includes multiple data compute nodes (in this case, virtual machines) 115-125 that connect to the smart NICs 105 and 110 in a passthrough mode (i.e., without having any sort of network virtualization processing applied within the virtualization software 130 of the host computer 100). Each of the VMs 115-125 has an associated virtual NIC (vNIC) 135-145 that connects to a different virtual function (VF) 161-164 of one of the smart NICs 105 and 110 via a Peripheral Component Interconnect Express (PCIe) fabric 165 (a motherboard-level interconnect that connects the physical processor of the host computer 100 to the physical interfaces of the smart NICs 105 and 110).

Each vNIC 135-145, and thus each VM 115-125, is bound to a different VF of one of the smart NICs 105 or 110. The VFs 161-164, in some embodiments, are virtualized PCIe functions exposed as interfaces of the smart NICs. Each VF is associated with a physical function (PF), which is a physical interface of the smart NIC that is recognized as a unique PCIe resource. In this case, the smart NIC 105 has one PF 170 and the smart NIC 110 has one PF 175, but in many cases each smart NIC will have more than one PF. The PF 170 is virtualized to provide at least the VFs 161-162 while the PF 175 is virtualized to provide at least the VFs 163-164.

In some embodiments, the VFs are provided so as to provide different VMs with different virtual interfaces of the smart NICs to which they can each connect. In some embodiments, VF drivers 150-160 execute in each of the VMs 115-125 to manage their respective connections to the VFs. As shown, in some embodiments, each VM 115-125 is associated with a vNIC 135-145 that is provided by the virtualization software 130 as a software emulation of the NIC. In different embodiments, the VMs 115-125 access the VFs either through their respective vNICs 135-145 or directly in a passthrough mode (in which the virtualization software 130 is not involved in most network communications). In yet other embodiments, the VMs 115-125 can switch between this passthrough mode and accessing the VFs via their respective vNICs 135-145. In either case, the virtualization software 130 is involved in allocating the VFs 161-164 to the VMs 115-125 and enabling the VFs to be accessible from the VF drivers 150-160.

In this example, different VMs are bound to VFs on different smart NICs. In some embodiments, which of the smart NICs is the active smart NIC for each VM is determined on a per-VM basis. In other embodiments, however, one of the smart NICs is the active smart NIC for all of the VMs (or other DCNs) on the host computer. It should also be noted that although in this case all of the networking operations have been shifted from the virtualization software 130 of the host computer 100 to the smart NICs 105 and 110, in other embodiments virtual switch(es) provided by the virtualization software 130 can connect directly to the PFs 170 and 175. In some such embodiments, data traffic is sent from a VM via a vNIC to the virtual switch, which provides the traffic to the PF. In this case, the virtual switch performs basic switching operations but leaves network virtualization operations to the smart NIC.

The smart NICs 105 and 110 also include physical network ports 181-184. In different embodiments, smart NICs may each include only a single physical network port or multiple (e.g., 2, 3, 4, etc.) physical network ports. These physical network ports 181-184 provide the physical communication to a datacenter network for the host computer 100. In addition, some embodiments provide a private communication channel 180 between the two smart NICs 105 and 110, which allows these smart NICs to communicate directly. This communication channel 180 may take various forms (e.g., direct physical connection, logical connection via the existing network, or connection via PCIe messages).

Finally, FIG. 1 illustrates that the smart NICs 105 and 110 perform network virtualization operations 185. In some embodiments, these operations can include logical switching and/or routing operations, distributed firewall operations, encapsulation, and other networking operations that are often performed in the virtualization software of host computers. In some embodiments, all of the smart NICs of a given host computer are provided with the same virtual networking configuration.

Though not shown in the figure, in some embodiments each smart NIC is a NIC that includes (i) a packet processing circuit, such as an application specific integrated circuit (ASIC), (ii) a general-purpose central processing unit (CPU), and (iii) memory. The packet processing circuit, in some embodiments, is an I/O ASIC that handles the processing of data messages forwarded to and from the DCNs in the host computer and is at least partly controlled by the CPU. In other embodiments, the packet processing circuit is a field-programmable gate array (FPGA) configured to perform packet processing operations or a firmware-programmable processing core specialized for network processing (which differs from the general-purpose CPU in that the processing core is specialized and thus more efficient at packet processing). The CPU executes a NIC operating system in some embodiments that controls the packet processing circuit and can run other programs. In some embodiments, the CPU configures the packet processing circuit to implement the network virtualization operations by configuring flow entries that the packet processing circuit uses to process data messages.

When a data message is sent by one of the VMs 115-125, that data message is (in software of the host computer 100) sent via the corresponding vNIC 135-145. The data message is passed through the PCIe bus 165 to the corresponding VF 161-164 of the appropriate smart NIC. The smart NIC ASIC processes the data message to apply the configured network virtualization operations 185, then (so long as the data message does not need to be sent to the other smart NIC of the host computer and the destination for the data message is external to the host computer) sends the data message out of one of its physical ports 181-184.

It should be noted that, while FIG. 1 illustrates a host computer with virtualization software on which various VMs operate, the discussion of smart NICs herein also applies to host computers hosting other types of virtualized DCNs (e.g., containers) as well as bare metal computing devices (i.e., on which the computer does not execute virtualization software). In the latter case, the bare metal computing device will typically directly access the PFs of multiple smart NICs rather than any VFs. That is, the smart NICs are used to provide networking operations (or other operations, such as storage virtualization) without the software on the computing device being aware of these operations.

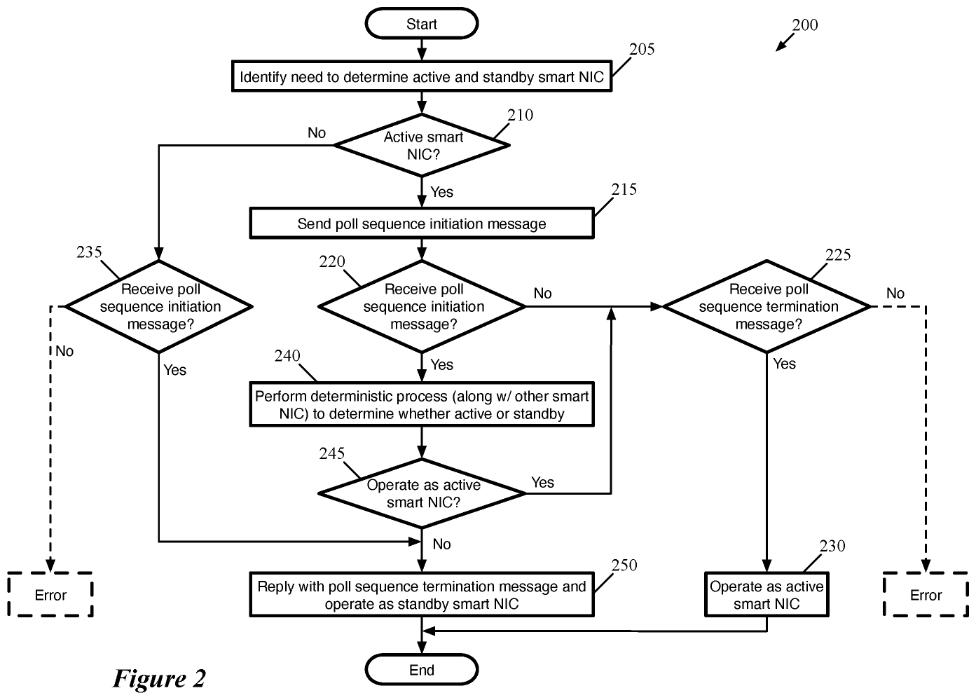

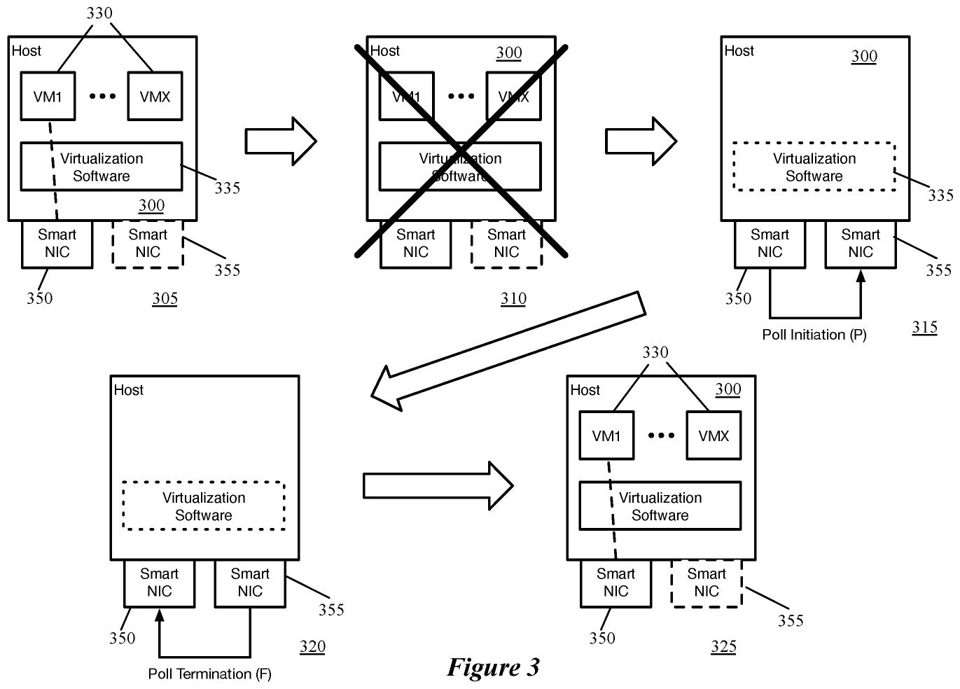

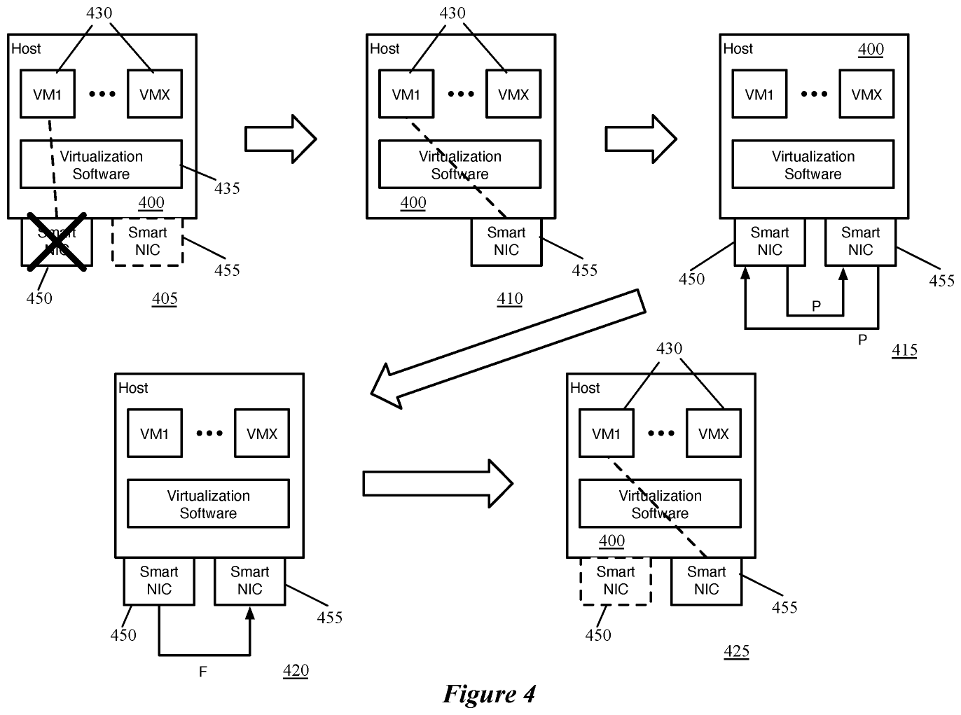

FIG. 2 conceptually illustrates a process 200 of some embodiments performed by a smart NIC to determine whether that smart NIC is the active smart NIC for a host computer. This process 200 is described in relation to the determination of an active smart NIC for the host computer as a whole (i.e., to handle the traffic for all of the DCNs executing on the host computer). In other embodiments, a similar process is performed for each DCN on the host computer to determine the active smart NIC for each DCN individually (i.e., the active smart NIC for a particular DCN handles all of the traffic for that DCN, but different smart NICs may be the active smart NIC for different DCNs). The process 200 is described by reference to FIGS. 3 and 4, which conceptually illustrate the identification of a single active smart NIC through datapath-based methods for different scenarios in which one or more of the smart NICs has rebooted.

As shown, the process 200 begins by identifying (at 205) a need to determine the active and standby smart NICs. In some embodiments, the process 200 is performed when one or more of the smart NICs of a host computer comes back online (e.g., boots up). When the smart NICs and host computer are operating normally, one of the smart NICs is designated as active and handles the traffic for the DCNs on the host computer while the other smart NIC is designated as standby and does not handle this traffic. In addition, during typical operation, a controller agent operating in the virtualization software could specify to the smart NICs which one operates as active and which operates as standby. However, situations such as crashes or deliberate reboots of either the host computer or individual smart NICs can result in situations requiring solutions that do not involve the host computer software (thus the impetus for a datapath-based solution).

For instance, FIG. 3 conceptually illustrates a situation in which an entire host computer 300 crashes (or is deliberately restarted) over five stages 305-325. The first stage 305 illustrates this computer 300 operating normally. A set of VMs 330 executes on top of virtualization software 335 on the host computer 300. The host computer 300 has two smart NICs 350 and 355, the first of which is designated as active and the second of which is designated as standby (and is thus shown with dashed lines). As shown, at least the first VM 330 sends and receives network traffic via the active smart NIC 350.

In the second stage 310, the entire host computer 300 is powered off, either deliberately or because the host crashes. In this situation, the smart NICs 350 and 355 also power off. The third stage 315 indicates that as the host computer 300 powers back on, the smart NICs 350 and 355 become operational prior to the host operating system and/or virtualization software fully restarting. While there is no need to send traffic from the host computer 300 (or its DCNs 330) at this point, it is possible that traffic could be sent to the host computer 300. Furthermore, in some embodiments, one of the smart NICs 350 and 355 (i.e., the active smart NIC) acts as a replication proxy within the datacenter for broadcast, multicast, and or unknown destination (BUM) traffic, even if the host computer 300 is not yet operating.

FIG. 4, on the other hand, conceptually illustrates a situation in which one of the smart NICs 450 (specifically, the active smart NIC in this case) crashes (or is deliberately powered off), then comes back online over five stages 405-425. The first stage 405 illustrates a host computer 400 operating normally, with a set of VMs 430 executing on top of virtualization software 435. The host computer 400 has two smart NICs 450 and 455, the first of which is designated as active and the second of which is designated as standby (and is thus shown with dashed lines). As shown, at least the first VM 430 sends and receives network traffic via the active smart NIC 450.

This first stage 405 also illustrates that the first (active) smart NIC 450 crashes (or is deliberately powered off). As shown in the second stage 410, this causes the second smart NIC 455 to take over the role of operating as the active smart NIC. In the third stage 415, the first smart NIC 450 has powered back on. At this point, there is the possibility that both smart NICs 450 and 455 believe they should operate as the active smart NIC for the host computer 400. In both of the situations shown in FIGS. 3 and 4, the optimal solution for determining which smart NIC is active should not require intervention of the virtualization software.

In the latter case shown in FIG. 4, the first smart NIC 450 is configured to begin the active NIC determination process because it has just booted up. However, the other smart NIC 455 should also perform the same process. For this other smart NIC 455 to be made aware and thus begin its own process, in some embodiments the PCIe bus (to which both of the smart NICs connect) automatically sends a hardware event signal to one smart NIC (in this case NIC 455) when the other smart NIC (in this case NIC 450) has restarted. In other embodiments, the smart NICs maintain a bidirectional forwarding detection (BFD) or other health monitoring protocol session while both are operational. Upon coming back up, the smart NIC that restarted (in this case NIC 450) will automatically re-initiate this session (or continue sending the BFD messages for the previous session), thereby indicating to the other smart NIC (in this case 455) that it has restarted, causing the other smart NIC to also initiate the active NIC determination process.

Returning to FIG. 2, the process 200 determines (at 210) whether the smart NIC performing the process is the active smart NIC (i.e., is either currently operating as the active smart NIC or believes that it should operate as the active smart NIC). That is, a currently active smart NIC would determine that should operate as the active smart NIC, but a newly restarted smart NIC might also come to the same conclusion (e.g., based on having been the active smart NIC prior to restarting).

If the current smart NIC determines that it should be the active smart NIC, the process 200 sends (at 215) a poll sequence initiation message to the other smart NIC (or another type of message that can prompt a reply). In some embodiments, this first message sent by the active (or believing itself active) smart NIC is a BFD poll sequence poll message. This is a BFD message with the “P” bit set, also referred to as a P (Poll) message. Such a P message is sent from one endpoint (in this case a smart NIC) to another endpoint (in this case the other smart NIC) and initiates a poll sequence for the other endpoint to complete by replying with a poll sequence termination message.

At this point, the other smart NIC will have initiated the same process. If that smart NIC also believes that it should be the active smart NIC, it will send its own poll sequence initiation message. On the other hand, if the other smart NIC believes that it should be the standby smart NIC, then that other smart NIC will send a poll sequence termination message. If using the BFD poll sequence, this termination message is a BFD message with the “F” bit set, also referred to as an F (Final) message.

Thus, the process 200 determines (at 220) whether a poll sequence initiation message has been received. If no initiation message is received, the process 200 also determines (at 225) whether a poll sequence termination message has been received. It should be understood that the process 200 is a conceptual process and that the smart NIC of some embodiments may not perform the specific actions shown in FIG. 2. For instance, in some embodiments, the smart NICs do not actually make specific determinations as to whether a poll sequence initiation message or poll sequence termination message has been received. Rather, the smart NICs of some embodiments receives these poll sequence messages as events and change state based on the message received.

If the process 200 sends a poll sequence initiation message (at 215) but receives neither a poll sequence termination message (indicating that the other smart NIC believes itself to be the standby smart NIC) nor a poll sequence initiation message (indicating that the other smart NIC believes itself to be the active smart NIC), then an error has occurred. This may indicate that the other smart NIC has crashed, lost connectivity to the smart NIC performing the process 200, etc.

However, if the process 200 receives (at 225) a poll sequence termination message, this indicates that the other smart NIC believes itself to be the standby smart NIC and has completed the poll sequence. The third stage 315 of FIG. 3 illustrates that the first smart NIC 350 sends a poll sequence initiation (P) message to the second smart NIC 355. Because the second smart NIC 355 was configured as the standby smart NIC prior to the host computer 300 shutting down, the second smart NIC 355 returns a poll sequence termination (F) message to the first smart NIC 350.

Based on receiving the poll sequence termination message, the process 200 proceeds to operate (at 230) as the active smart NIC. In this case, the other smart NIC will operate as the standby smart NIC for the host computer. The fifth stage 325 of FIG. 3 illustrates that after the second smart NIC 355 sends the poll sequence termination message, the first smart NIC 350 operates as the active smart NIC and the second smart NIC 355 operates as the standby smart NIC. After the virtualization software 335 and VMs 330 fully come back up, the VMs 330 can communicate with the datacenter network via the active smart NIC 350.

Returning to FIG. 2, if the smart NIC performing the process 200 determines (at 210) that it is not the active smart NIC, then this process 200 determines (at 235) whether a poll sequence initiation message has been received. If the smart NICs have entered a state in which the active smart NIC determination is expected, then if one smart NIC determines that it is not the active smart NIC, the other smart NIC should make the opposite determination and send a poll sequence initiation message. In this case, if such a poll sequence initiation message is received, the process 200 replies (at 250) with a poll sequence termination message and operates as the standby smart NIC. The process 200 then ends. This branch of the process 200 is performed by the second smart NIC 355 shown in FIG. 3.

If no poll sequence initiation message is received at a smart NIC that believes itself to be the standby smart NIC, then this is indicative of an error in the system. This error could be due to both smart NICs operating as the standby smart NIC, which is a problem as neither will then be configured to process data traffic for the host computer. The problem could also arise from a connectivity issue at one of the smart NICs or from the other smart NIC (i.e., that is not the smart NIC performing the process 200) crashing or being deliberately shut down.

In the above-described branches of the process 200, only one of the smart NICs sends a poll initiation message, so there is no conflict as to which of the smart NICs is the active smart NIC. However, if the smart NIC receives a poll sequence initiation message (at 220) after having sent its own such message, then the process 200 performs (at 240) a deterministic process to determine whether to operate as the active smart NIC or the standby smart NIC. In some embodiments, this deterministic process is performed by both smart NICs. Due to the deterministic nature, both smart NICs will generate the same output and therefore come to the same determination as to which of the smart NICs should operate as the active smart NIC going forward.

In some embodiments, this deterministic process is a comparison of hardware identifiers of the two smart NICs to which both of the smart NIC have access. For instance, in some embodiments, the smart NICs each have PCIe identifiers. Each smart NICs PCIe identifier is accessible to the other smart NICs, so both smart NICs compare these identifiers and identify the smart NIC with the higher (or lower) value as the active smart NIC.

Other embodiments compare the timestamps of the most recent configuration update for the two smart NICs. In this case, the first messages sent in each direction (e.g., the poll sequence initiation messages) include the timestamp of the most recent configuration for the sending smart NIC, thereby allowing the two smart NICs to make the same comparison. If both smart NICs were most recently updated at the same time, then the smart NICs compare the hardware identifiers as a tiebreaker in some embodiments. The smart NICs perform networking for the DCNs operating on the host computer, which may require regular configuration changes as the logical networks to which the DCNs belong are modified (e.g., as DCNs are added or removed from the virtual network, as new security policies are defined, etc.). As such, the configuration for the smart NICs will be updated relatively often in many cases.

The third stage 415 of FIG. 4 illustrates that both smart NICs 450 and 455 believe themselves to be the active smart NIC and therefore both send their own poll sequence initiation (P) messages to the other smart NIC. In this case, the second smart NIC 455 has been operating as the active smart NIC while the first smart NIC 450 was down, but the first smart NIC 450 was operating as the active smart NIC prior to crashing and thus reboots configured to operate as the active smart NIC. The two smart NICs 450 and 455 thus both perform the same deterministic process to identify which should operate as the active smart NIC.

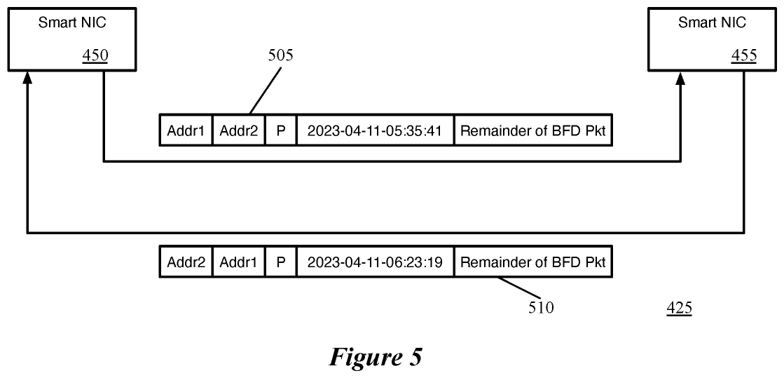

FIG. 5 conceptually illustrates the two P messages 505 and 510 sent by the smart NICs 450 and 455 at the third stage 415. As shown, the first smart NIC 450 sends a poll sequence initiation message 505 with its address (e.g., its MAC and/or IP addresses) as a source address, the address of the second smart NIC 455 as a destination address, and the P bit set. This message 505 also includes a timestamp (Apr. 11, 2023, 05:35:41) of the most recent configuration update for the first smart NIC 450, which may be stored in reserve bits of the BFD message. Similarly, the second smart NIC 455 sends a poll sequence initiation message 510 with the addresses reversed and the P bit set. This message 510 also includes a timestamp (Apr. 11, 2023, 06:23:19) of the most recent configuration update for the second smart NIC 455. These messages allow the two smart NICs 450 and 455 to both perform a comparison of the timestamps and determine that the second smart NIC 455 was updated more recently (e.g., after the first smart NIC 450 had crashed).

As shown in FIG. 2, if the result of the deterministic process is that the smart NIC performing that process should operate as the standby smart NIC, the process 200 replies (at 250) with a poll sequence termination message and operates as the standby smart NIC. On the other hand, if the result of the deterministic process is that the smart NIC performing that process should operate as the active smart NIC, the process 200 proceeds to 225, described above, at which a poll sequence termination message should be received. Assuming such a message is received, the process 200 proceeds to 230 for the smart NIC to operate as the active smart NIC. The process 200 then ends.

The fourth stage 420 of FIG. 4 illustrates that the first smart NIC 450 (having been updated less recently) sends a poll sequence termination (F) message to the second smart NIC 455. The fifth stage 425 illustrates that after the first smart NIC 450 sends the poll sequence termination message, the second smart NIC 455 operates as the active smart NIC and the first smart NIC 450 operates as the standby smart NIC. The VMs 430 now communicate with the datacenter network via the active smart NIC 455.

In the examples described herein relate to a host computer having two smart NICs in an active-standby pair. Some embodiments allow for more than two smart NICs with only one active smart NIC (or only one active for each DCN). In some such embodiments, when a smart NIC identifies itself as the active smart NIC, it initiates a polling session with each of the other smart NICs. In other embodiments, other techniques are used to identify the active smart NIC among a group of more than two (e.g., using a leader election protocol).

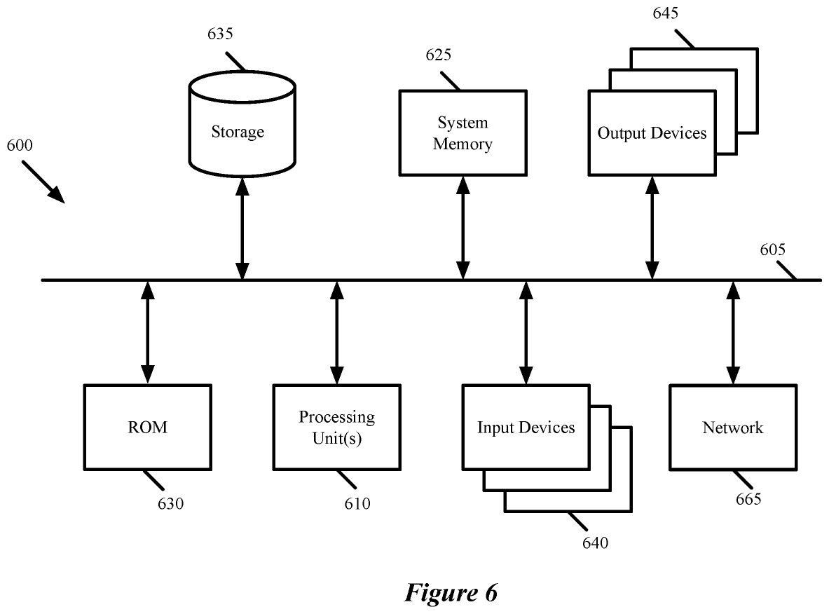

FIG. 6 conceptually illustrates an electronic system 600 with which some embodiments of the invention are implemented. The electronic system 600 may be a computer (e.g., a desktop computer, personal computer, tablet computer, server computer, mainframe, a blade computer etc.), phone, PDA, or any other sort of electronic device. Such an electronic system includes various types of computer readable media and interfaces for various other types of computer readable media. Electronic system 600 includes a bus 605, processing unit(s) 610, a system memory 625, a read-only memory 630, a permanent storage device 635, input devices 640, and output devices 645.

The bus 605 collectively represents all system, peripheral, and chipset buses that communicatively connect the numerous internal devices of the electronic system 600. For instance, the bus 605 communicatively connects the processing unit(s) 610 with the read-only memory 630, the system memory 625, and the permanent storage device 635.

From these various memory units, the processing unit(s) 610 retrieve instructions to execute and data to process in order to execute the processes of the invention. The processing unit(s) may be a single processor or a multi-core processor in different embodiments.

The read-only-memory (ROM) 630 stores static data and instructions that are needed by the processing unit(s) 610 and other modules of the electronic system. The permanent storage device 635, on the other hand, is a read-and-write memory device. This device is a non-volatile memory unit that stores instructions and data even when the electronic system 600 is off. Some embodiments of the invention use a mass-storage device (such as a magnetic or optical disk and its corresponding disk drive) as the permanent storage device 635.

Other embodiments use a removable storage device (such as a floppy disk, flash drive, etc.) as the permanent storage device. Like the permanent storage device 635, the system memory 625 is a read-and-write memory device. However, unlike storage device 635, the system memory is a volatile read-and-write memory, such a random-access memory. The system memory stores some of the instructions and data that the processor needs at runtime. In some embodiments, the invention's processes are stored in the system memory 625, the permanent storage device 635, and/or the read-only memory 630. From these various memory units, the processing unit(s) 610 retrieve instructions to execute and data to process in order to execute the processes of some embodiments.

The bus 605 also connects to the input and output devices 640 and 645. The input devices enable the user to communicate information and select commands to the electronic system. The input devices 640 include alphanumeric keyboards and pointing devices (also called “cursor control devices”). The output devices 645 display images generated by the electronic system. The output devices include printers and display devices, such as cathode ray tubes (CRT) or liquid crystal displays (LCD). Some embodiments include devices such as a touchscreen that function as both input and output devices.

Finally, as shown in FIG. 6, bus 605 also couples electronic system 600 to a network 665 through a network adapter (not shown). In this manner, the computer can be a part of a network of computers (such as a local area network (“LAN”), a wide area network (“WAN”), or an Intranet, or a network of networks, such as the Internet. Any or all components of electronic system 600 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms display or displaying means displaying on an electronic device. As used in this specification, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

This specification refers throughout to computational and network environments that include virtual machines (VMs). However, virtual machines are merely one example of data compute nodes (DCNs) or data compute end nodes, also referred to as addressable nodes. DCNs may include non-virtualized physical hosts, virtual machines, containers that run on top of a host operating system without the need for a hypervisor or separate operating system, and hypervisor kernel network interface modules.

VMs, in some embodiments, operate with their own guest operating systems on a host using resources of the host virtualized by virtualization software (e.g., a hypervisor, virtual machine monitor, etc.). The tenant (i.e., the owner of the VM) can choose which applications to operate on top of the guest operating system. Some containers, on the other hand, are constructs that run on top of a host operating system without the need for a hypervisor or separate guest operating system. In some embodiments, the host operating system uses name spaces to isolate the containers from each other and therefore provides operating-system level segregation of the different groups of applications that operate within different containers. This segregation is akin to the VM segregation that is offered in hypervisor-virtualized environments that virtualize system hardware, and thus can be viewed as a form of virtualization that isolates different groups of applications that operate in different containers. Such containers are more lightweight than VMs.

Hypervisor kernel network interface modules, in some embodiments, is a non-VM DCN that includes a network stack with a hypervisor kernel network interface and receive/transmit threads. One example of a hypervisor kernel network interface module is the vmknic module that is part of the ESXi™ hypervisor of VMware, Inc.

It should be understood that while the specification refers to VMs, the examples given could be any type of DCNs, including physical hosts, VMs, non-VM containers, and hypervisor kernel network interface modules. In fact, the example networks could include combinations of different types of DCNs in some embodiments.

While the invention has been described with reference to numerous specific details, one of ordinary skill in the art will recognize that the invention can be embodied in other specific forms without departing from the spirit of the invention. In addition, a number of the figures (including FIG. 2) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

1. A method comprising:
at a first smart network interface controller (NIC) of a plurality of smart NICs of a host computer, each of the smart NICs executing a smart NIC operating system that performs networking operations for a set of data compute machines executing on the host computer:
when the first smart NIC identifies itself as an active smart NIC of the host computer, sending a first message through a datapath to a second smart NIC of the host computer to verify whether the second smart NIC identifies as an active smart NIC or a standby smart NIC for the host computer; and
if the second smart NIC sends a reply second message to the first smart NIC through the datapath, (i) determining that the second smart NIC identifies as a standby smart NIC and (ii) operating to process data traffic sent to and from the host computer as the active smart NIC, wherein only one of the plurality of smart NICs operates as the active smart NIC.

2. The method of claim 1, wherein the first message is a polling sequence initiation message and the reply second message is a polling sequence termination message.

3. The method of claim 2, wherein if the second smart NIC sends a second polling sequence initiation message to the first smart NIC through the datapath, both the first and second smart NICs identify as active smart NICs.

4. The method of claim 3, wherein one of the first and second smart NICs determines that the other smart NIC should operate as the active smart NIC for the host computer and sends the polling sequence termination message.

5. The method of claim 2, wherein the polling sequence initiation message and polling sequence termination message are bidirectional forwarding detection (BFD) poll sequence messages.

6. The method of claim 1, wherein if the second smart NIC sends a message to the first smart NIC that matches the first message rather than sending the reply second message, (i) the first and second smart NICs perform a same deterministic process to determine which of the first and second smart NICs will operate as the active smart NIC and (ii) the smart NIC of the first and second smart NICs that determines itself as the standby smart NIC sends a reply message to the other smart NIC.

7. The method of claim 6, wherein the deterministic process comprises comparing hardware identifiers of the first and second smart NICs.

8. The method of claim 6, wherein:
the first message comprises a first timestamp of a most recent configuration update for the first smart NIC;
the message sent by the second smart NIC that matches the first message comprises a second timestamp of a most recent configuration update for the second smart NIC;
the deterministic process comprises comparing the first and second timestamps; and
the first smart NIC determines itself as the active smart NIC when the first timestamp is more recent than the second timestamp and the second smart NIC determines itself as the active smart NIC when the second timestamp is more recent than the first timestamp.

9. The method of claim 8, wherein the deterministic process further comprises comparing hardware identifiers of the first and second smart NICs when the first and second timestamps are the same.

10. The method of claim 1, wherein:
prior to the first smart NIC sending the first message, the host computer reboots; and
the first and second smart NICs reboot faster than software of the host computer such that virtualization software of the host computer is unable to specify for the smart NICs which of the smart NICs will operate as the active smart NIC.

11. The method of claim 1, wherein:
prior to the first smart NIC sending the first message, the first smart NIC crashes and reboots;
the first smart NIC was the active smart NIC for the host computer prior to rebooting and thus identifies itself as the active smart NIC upon rebooting; and
the second smart NIC operates as the active smart NIC for the host computer upon the first smart NIC crashing.

12. The method of claim 1, wherein:
prior to the first smart NIC sending the first message, the second smart NIC crashes and reboots;
the first smart NIC receives a hardware event signal from a bus of the host computer to which the first and second smart NICs connect indicating that the second smart NIC has rebooted, prompting the first smart NIC to send the first message.

13. The method of claim 1, wherein:
prior to the first smart NIC sending the first message, the second smart NIC crashes and reboots;
prior to the second smart NIC crashing and rebooting, the first and second smart NICs exchange health monitoring messages via an established health monitoring protocol session; and
upon the second smart NIC rebooting, the second smart NIC automatically reestablishes the health monitoring protocol session, prompting the first smart NIC to send the first message.

14. A non-transitory machine-readable medium storing a program for execution by at least one processing unit of a first smart network interface controller (NIC) of a plurality of smart NICs of a host computer, each of the smart NICs executing a smart NIC operating system that performs networking operations for a set of data compute machines executing on the host computer, the program comprising sets of instructions for:
when the first smart NIC identifies itself as an active smart NIC of the host computer, sending a first message through a datapath to a second smart NIC of the host computer to verify whether the second smart NIC identifies as an active smart NIC or a standby smart NIC for the host computer; and
if the second smart NIC sends a reply second message to the first smart NIC through the datapath, (i) determining that the second smart NIC identifies as a standby smart NIC and (ii) operating to process data traffic sent to and from the host computer as the active smart NIC, wherein only one of the plurality of smart NICs operates as the active smart NIC.

15. The non-transitory machine-readable medium of claim 14, wherein the first message is a polling sequence initiation message and the reply second message is a polling sequence termination message.

16. The non-transitory machine-readable medium of claim 15, wherein, if the second smart NIC sends a second polling sequence initiation message to the first smart NIC through the datapath:
both the first and second smart NICs identify as active smart NICs; and
one of the first and second smart NICs determines that the other smart NIC should operate as the active smart NIC for the host computer and sends the polling sequence termination message.

17. The non-transitory machine-readable medium of claim 14, wherein the program further comprises sets of instructions for, if the second smart NIC sends a message to the first smart NIC that matches the first message rather than sending the reply second message:
performing a deterministic process to determine which of the first and second smart NICs will operate as the active smart NIC, wherein the second smart NIC performs the same deterministic process; and
if the first smart NIC determines itself as the standby smart NIC, sending a reply message to the second smart NIC, wherein the second smart NIC sends a reply message to the first smart NIC if the second smart NIC determines itself as the standby smart NIC.

18. The non-transitory machine-readable medium of claim 17, wherein the set of instructions for performing the deterministic process comprises a set of instructions for comparing hardware identifiers of the first and second smart NICs.

19. The non-transitory machine-readable medium of claim 17, wherein:
the first message comprises a first timestamp of a most recent configuration update for the first smart NIC;
the message sent by the second smart NIC that matches the first message comprises a second timestamp of a most recent configuration update for the second smart NIC;
the set of instructions for performing the deterministic process comprises a set of instructions for comparing the first and second timestamps; and
the first smart NIC determines itself as the active smart NIC when the first timestamp is more recent than the second timestamp and the second smart NIC determines itself as the active smart NIC when the second timestamp is more recent than the first timestamp.

20. The non-transitory machine-readable medium of claim 19, wherein the set of instructions for performing the deterministic process further comprises a set of instructions for comparing hardware identifiers of the first and second smart NICs when the first and second timestamps are the same.
